(19) United States
(12) Patent Application Publication
(10) Pub. No.: US 2004/0057695 A1
(43) Pub. Date: Mar. 25, 2004

(54) Information reproducing apparatus and information reproducing method

(75) Inventors: Hiroyuki Kobayashi, Kawagoe-shi (JP); Takehiko Mizushiri, Kawagoe-shi (JP)

Correspondence Address: YOUNG & THOMPSON, 745 SOUTH 23RD STREET 2ND FLOOR, ARLINGTON, VA, 22202

(73) Assignees: PIONEER CORPORATION, TOKYO (JP); PIONEER SYSTEM TECHNOLOGIES CORPORATION, SENDAI-SHI (JP)

(21) Appl. No.: 10/663,763

(22) Filed: Sep. 17, 2003

(30) Foreign Application Priority Data
Sep. 17, 2002 (JP) 2002-270531

(51) Int. Cl. H04N 5/91

(52) U.S. Cl. 386/46

(57) ABSTRACT

When a power of a DVD audio player is turned off, a track number relating to a track that is reproduced until the power is turned off, and a group number relating to a group including the track, and a display list number corresponding to the still picture information unit that is reproduced until the power is turned off are stored in a storage unit. When the reproduction is resumed, a reproduction position corresponding to a reproduction starting time of the still picture information unit that was reproduced until the power of the DVD audio player is turned off is determined on the basis of the group number, the track number and the display list number, all of which are stored in the storage unit, and this reproduction position is set as a reproducing resuming position.

### BACKGROUND OF THE INVENTION

1. Field of the Invention

The present invention relates to an information reproducing apparatus and method, such as a DVD player, for reproducing contents information such as audio information or video information. The present invention further relates to a computer program product for serving a computer as the information reproducing apparatus.

2. Description of the Related Art

Some of information reproducing apparatuses including a DVD audio player or the like have a function of reproducing still pictures in addition to sound. Specifically, audio information, multiple units of still picture information, and reproduction control information are recorded in a recording medium such as a DVD. The reproduction control information is information for indicating a reproduction start time point or the like of each of the multiple units of still picture information to be reproduced during a reproduction of the audio information. The information reproducing apparatus reproduces the audio information and the still picture information recorded in the DVD, so that a user can see still pictures while listening to music or the like.

There are presented various ways of reproducing the still picture information, for example including a slide show reproduction, that is, a method of reproducing the multiple units of still picture information one by one at predetermined time intervals during the reproduction of the audio information. The above-mentioned reproduction control information includes therein the reproduction start time point of each of the multiple units of still picture information. The information reproducing apparatus reproduces the multiple units of still picture information one by one on the basis of the reproduction control information during the reproduction of the audio information. Thereby, the reproduction of the still picture information can be synchronized with the reproduction of the audio information, for the slide show reproduction. This technique is disclosed in Japanese Patent Application Laid-Open No. 2001-285783 (pages 3-5, FIG. 6).

Assume that a user turns off the power of the information reproducing apparatus to stop or interrupt the reproduction while the information reproducing apparatus is presently reproducing the information recorded in the recording medium. Then assume that the user turns on the power of the information reproducing apparatus to resume the reproduction of the information recorded in the recording medium, immediately after that or after a while. In this situation, generally, the information reproducing apparatus starts to reproduce the information recorded in the recording medium from the first unless otherwise instructed specifically by the user.

It is convenient, however, to resume the reproduction from a position at which the reproduction is stopped or interrupted, in the case that the user turns on the power of the information reproducing apparatus again to resume the reproduction of the information recorded in the recording medium.

Hence, there has been proposed an information reproducing apparatus capable of recording a reproduction time of information under reproduction when the power of the information reproducing apparatus is turned off, reading the reproduction time that is stored in a memory or the like to obtain a reproduction resuming position of the information from the reproduction time, and resuming the reproduction of the information from the reproduction resuming position.

In the case that the information reproducing apparatus capable of reproducing the still picture in addition to the sound performs the slide show reproduction, however, the still picture and sound are synchronously reproduced, and thereby the above-mentioned approach, i.e. obtaining the reproduction resuming position on the basis of the reproduction time of the previously reproduced sound, leaves some problems as follows.

For instance, if the time point at which the previous reproduction of the still picture and sound has been interrupted is just before a time point at which the still picture is to be changed, the still picture is changed to another one immediately after resuming the reproduction owing to the reproduction resuming position obtained only from the reproduction time of the previously reproduced sound. Such a situation imposes an inconvenience on the user, who cannot watch the still picture comfortably.

On the other hand, in some cases of the slide show reproduction, “a time position at which the still picture is to be changed to another one” (hereinafter referred to as a “still picture switching point”) may be preset so as to coincide with “a time point at which a tone of a music composition is changed from a melody line to a theme” (hereinafter referred to as a “tone changing point”). In this case, if the reproduction resuming position is set to the still picture switching point, the reproduction of the music composition can be resumed from a changing point of the music movement, or the tone changing point for example. As a result, the user can listen to the music composition comfortably. Nevertheless, the conventional information reproducing apparatus has not addressed nor succeeded in such a reproduction system.

### SUMMARY OF THE INVENTION

The present invention has been accomplished in view of above problems for example. It is therefore an object of the present invention to provide an information reproducing apparatus and method capable of reproducing the still picture and sound from the still picture switching point, in the case that the reproduction of the still picture and sound has been interrupted and then is resumed.

The above object of the present invention can be achieved by an information reproducing apparatus for reproducing audio information and a plurality of still picture information units on the basis of reproduction control information for indicating reproduction starting time points of the respective plurality of still picture information units to be reproduced during a reproduction of the audio information, provided with: an audio reproducing device for reproducing the audio information; a still picture reproducing device for reproducing the plurality of still picture information units in sequence by switching the plurality of still picture information units one after another according to the reproduction starting time points; a storing device for storing information, as interruption information, to identify a still picture information unit that is reproduced until the reproduction by the audio reproducing device or the still picture reproducing device is interrupted; and a setting device for setting a reproduction resuming position of the audio information, on the basis of the interruption information that is stored in the storing device.

The above object of the present invention can be achieved by an information reproducing apparatus for reproducing audio information and a plurality of still picture information units on the basis of reproduction control information for indicating reproduction starting time points of the respective plurality of still picture information units to be reproduced during a reproduction of the audio information, provided with: an audio reproducing device for reproducing the audio information; a still picture reproducing device for reproducing the plurality of still picture information units in sequence by switching the plurality of still picture information units one after another according to the reproduction starting time points; a storing device for storing information, as interruption information, to identify a still picture information unit to which a reproduction starting time nearest to an interruption time point that the reproduction by the audio reproducing device or the still picture reproducing device is interrupted is assigned, and a setting device for setting a reproduction resuming position of the audio information, on the basis of the interruption information that is stored in the storing device.

The above object of the present invention can be achieved by an information reproducing apparatus for reproducing audio information and a plurality of still picture information units on the basis of reproduction control information for indicating reproduction starting time points of the respective plurality of still picture information units to be reproduced during a reproduction of the audio information, provided with: an audio reproducing device for reproducing the audio information; a still picture reproducing device for reproducing the plurality of still picture information units in sequence by switching the plurality of still picture information units one after another according to the reproduction starting time points; a storing device for storing information, as interruption information, to indicate an interruption time point that the reproduction by the audio reproducing device or the still picture reproducing device is interrupted; and a setting device for identifying a still picture information unit that is reproduced until the reproduction is interrupted, on the basis of the interruption information that is stored in the storing device, and for setting a reproduction resuming position of the audio information, on the basis of the identified still picture information unit.

The above object of the present invention can be achieved by an information reproducing apparatus for reproducing audio information and a plurality of still picture information units on the basis of reproduction control information for indicating reproduction starting time points of the respective plurality of still picture information units to be reproduced during a reproduction of the audio information, provided with: an audio reproducing device for reproducing the audio information; a still picture reproducing device for reproducing the plurality of still picture information units in sequence by switching the plurality of still picture information units one after another according to the reproduction starting time points; a storing device for storing information, as interruption information, to indicate an interruption time point that the reproduction by the audio reproducing device or the still picture reproducing device is interrupted; and a setting device for identifying a still picture information unit to which a reproduction starting time point nearest to the interruption time point is assigned on the basis of the interruption information that is stored in the storing device, and for setting a reproduction resuming position of the audio information, on the basis of the identified still picture information unit.

The above object of the present invention can be achieved by an information reproducing method of reproducing audio information and a plurality of still picture information units on the basis of reproduction control information for indicating reproduction starting time points of the respective plurality of still picture information units to be reproduced during a reproduction of the audio information, provided with: an audio reproducing process of reproducing the audio information; a still picture reproducing process of reproducing the plurality of still picture information units in sequence by switching the plurality of still picture information units one after another according to the reproduction starting time points; a storing process of storing information, as interruption information, to identify a still picture information unit that is reproduced until the reproduction in the audio reproducing process or the still picture reproducing process is interrupted; and a setting process of setting a reproduction resuming position of the audio information, on the basis of the interruption information that is stored in the storing process.

The above object of the present invention can be achieved by an information reproducing method of reproducing audio information and a plurality of still picture information units on the basis of reproduction control information for indicating reproduction starting time points of the respective plurality of still picture information units to be reproduced during a reproduction of the audio information, provided with: an audio reproducing process of reproducing the audio information; a still picture reproducing process of reproducing the plurality of still picture information units in sequence by switching the plurality of still picture information units one after another according to the reproduction starting time points; a storing process of storing information, as interruption information, to identify a still picture information unit to which a reproduction starting time nearest to an interruption time point that the reproduction in the audio reproducing process or the still picture reproducing process is interrupted is assigned, and a setting process of setting a reproduction resuming position of the audio information, on the basis of the interruption information that is stored in the storing process.

The above object of the present invention can be achieved by an information reproducing method of reproducing audio information and a plurality of still picture information units on the basis of reproduction control information for indicating reproduction starting time points of the respective plurality of still picture information units to be reproduced during a reproduction of the audio information, provided with: an audio reproducing process of reproducing the audio information; a still picture reproducing process of reproducing the plurality of still picture information units in sequence by switching the plurality of still picture information units one after another according to the reproduction starting time points; a storing process of storing information, as interruption information, to indicate an interruption time point that the reproduction in the audio reproducing process or the still picture reproducing process is interrupted; and a setting process of identifying a still picture information unit that is reproduced until the reproduction is interrupted, on the basis of the interruption information that is stored in the storing process, and for setting a reproduction resuming position of the audio information, on the basis of the identified still picture information unit.

The above object of the present invention can be achieved by an information reproducing method of reproducing audio information and a plurality of still picture information units on the basis of reproduction control information for indicating reproduction starting time points of the respective plurality of still picture information units to be reproduced during a reproduction of the audio information, provided with: an audio reproducing process of reproducing the audio information; a still picture reproducing process of reproducing the plurality of still picture information units in sequence by switching the plurality of still picture information units one after another according to the reproduction starting time points; a storing process of storing information, as interruption information, to indicate an interruption time point that the reproduction in the audio reproducing process or the still picture reproducing process is interrupted; and a setting process of identifying a still picture information unit to which a reproduction starting time point nearest to the interruption time point is assigned on the basis of the interruption information that is stored in the storing process, and for setting a reproduction resuming position of the audio information, on the basis of the identified still picture information unit.

The above object of the present invention can be achieved by a computer program product in a computer-readable medium for tangibly embodying a program of instructions executable by a computer to make the computer function as an information reproducing apparatus for reproducing audio information and a plurality of still picture information units on the basis of reproduction control information for indicating reproduction starting time points of the respective plurality of still picture information units to be reproduced during a reproduction of the audio information. The information reproducing apparatus is provided with: an audio reproducing device for reproducing the audio information; a still picture reproducing device for reproducing the plurality of still picture information units in sequence by switching the plurality of still picture information units one after another according to the reproduction starting time points; a storing device for storing information, as interruption information, to identify a still picture information unit that is reproduced until the reproduction by the audio reproducing device or the still picture reproducing device is interrupted; and a setting device for setting a reproduction resuming position of the audio information, on the basis of the interruption information that is stored in the storing device.

The above object of the present invention can be achieved by a computer program product in a computer-readable medium for tangibly embodying a program of instructions executable by a computer to make the computer function as an information reproducing apparatus for reproducing audio information and a plurality of still picture information units on the basis of reproduction control information for indicating reproduction starting time points of the respective plurality of still picture information units to be reproduced during a reproduction of the audio information. The information reproducing apparatus is provided with: an audio reproducing device for reproducing the audio information; a still picture reproducing device for reproducing the plurality of still picture information units in sequence by switching the plurality of still picture information units one after another according to the reproduction starting time points; a storing device for storing information, as interruption information, to identify a still picture information unit to which a reproduction starting time nearest to an interruption time point that the reproduction by the audio reproducing device or the still picture reproducing device is interrupted is assigned, and a setting device for setting a reproduction resuming position of the audio information, on the basis of the interruption information that is stored in the storing device.

The above object of the present invention can be achieved by a computer program product in a computer-readable medium for tangibly embodying a program of instructions executable by a computer to make the computer function as an information reproducing apparatus for reproducing audio information and a plurality of still picture information units on the basis of reproduction control information for indicating reproduction starting time points of the respective plurality of still picture information units to be reproduced during a reproduction of the audio information. The information reproducing apparatus is provided with: an audio reproducing device for reproducing the audio information; a still picture reproducing device for reproducing the plurality of still picture information units in sequence by switching the plurality of still picture information units one after another according to the reproduction starting time points; a storing device for storing information, as interruption information, to indicate an interruption time point that the reproduction by the audio reproducing device or the still picture reproducing device is interrupted; and a setting device for identifying a still picture information unit that is reproduced until the reproduction is interrupted, on the basis of the interruption information that is stored in the storing device, and for setting a reproduction resuming position of the audio information, on the basis of the identified still picture information unit.

The above object of the present invention can be achieved by a computer program product in a computer-readable medium for tangibly embodying a program of instructions executable by a computer to make the computer function as an information reproducing apparatus for reproducing audio information and a plurality of still picture information units on the basis of reproduction control information for indicating reproduction starting time points of the respective plurality of still picture information units to be reproduced during a reproduction of the audio information. The information reproducing apparatus is provided with: an audio reproducing device for reproducing the audio information; a still picture reproducing device for reproducing the plurality of still picture information units in sequence by switching the plurality of still picture information units one after another according to the reproduction starting time points; a storing device for storing information, as interruption information, to indicate an interruption time point that the reproduction by the audio reproducing device or the still picture reproducing device is interrupted; and a setting device for identifying a still picture information unit to which a reproduction starting time point nearest to the interruption time point is assigned on the basis of the interruption information that is stored in the storing device, and for setting a reproduction resuming position of the audio information, on the basis of the identified still picture information unit.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram illustrating an information reproducing apparatus according to a first embodiment of the present invention;

FIG. 2 is an explanation view illustrating a temporal relationship between audio information and still picture information to be reproduced during a reproduction of the audio information when both kinds of information are reproduced;

FIG. 3 is an explanation view illustrating a state after the reproduction of the audio information with the still picture information is started in FIG. 2;

FIG. 4 is an explanation view illustrating a state after the reproduction of the audio information with the still picture information is resumed in FIG. 2;

FIG. 5 is an explanation view illustrating another state after the reproduction of the audio information with the still picture information is resumed in FIG. 2;

FIG. 6 is a block diagram illustrating a configuration of a DVD audio player according to a first example;

FIG. 7 is an explanation view illustrating an example of display list information;

FIG. 8 is an explanation view illustrating a temporal relationship between audio information associated with the track #1 and still picture information associated with the track #1 when both kinds of information is reproduced;

FIG. 9 is a flow chart illustrating a reproduction interrupting process according to the first example;

FIG. 10 is a flow chart illustrating a reproduction resuming process according to the first example;

FIG. 11 is a flow chart illustrating a reproduction interrupting process according to a second example;

FIG. 12 is a flow chart illustrating a reproduction interrupting process according to a third example;

FIG. 13 is a flow chart illustrating a reproduction resuming process according to the third example;

FIG. 14 is a flow chart illustrating a reproduction resuming position setting process according to the third example; and

FIG. 15 is a flow chart illustrating a reproduction resuming position setting process according to a fourth example.

### DETAILED DESCRIPTION OF THE PREFERRED EMBODIMENTS

The preferred embodiments of the present invention will now be discussed, referring to drawings.

(First Embodiment)

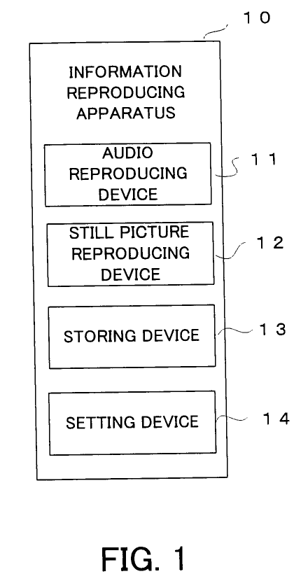

A first Embodiment of the present invention will now be discussed, with referring to FIG. 1 to FIG. 4.

Firstly, a configuration of the information reproducing apparatus according to the first embodiment will now be discussed, with referring to FIG. 1. FIG. 1 shows the construction of the information reproducing apparatus according to the first embodiment. The information reproducing apparatus 10 according to the first embodiment is an information reproducing apparatus for reproducing audio information and multiple units of still picture information (still picture information units), on the basis of reproduction control information indicating reproduction starting time points for the respective still picture information units to be reproduced during a reproduction of the audio information.

The information reproducing apparatus 10 may be a DVD audio player, a DVD karaoke player or the like, for example. Incidentally, the information reproducing apparatus 10 may be a type of information reproducing apparatus for reproducing audio information and still picture information recorded in a recording medium, or may be a type of information reproducing apparatus for reproducing audio information and still picture information delivered via Internet or the like.

The audio information is that which sound such as music is transformed into some sort of signal or data. The still picture information is that which a still picture(s) is transformed into a sort of signal or data. Relating to this, it is the simplest construction that a unit of still picture information corresponds to one still picture. Nevertheless, this construction is not restrictive.

The reproduction control information is information for indicating reproduction starting time points of the respective still picture information units to be reproduced during the reproduction of the audio information. The way of indicating the reproduction starting time point of the still picture information unit may be various. For example, it may be a way of recording a time period from a reproduction starting time point of audio information to the reproduction starting time point of the still picture information unit, a way of recording a reproduction order of the still picture information units and a display period of each still picture information unit. Insofar as the reproduction starting time point of each still picture information unit to be reproduced during the reproduction of the audio information can be identified, any way is applicable.

The audio information, still picture information units and reproduction control information may be of recorded in a recording medium such as a DVD, or may be of delivered via Internet or the like.

As shown in FIG. 1, the information reproducing apparatus 10 includes: an audio reproducing device 11 for reproducing audio information; a still picture reproducing device 12 for reproducing the still picture information units in sequence by switching the still picture information units one after another according to the reproduction starting time points; a storing device 13 for storing information, as interruption information, to identify a still picture information unit that is reproduced until the reproduction by the audio reproducing device 11 or the still picture reproducing device 12 is interrupted; and a setting device 14 for setting a reproduction resuming position of the audio information, on the basis of the interruption information stored in the storing device 13.

In the case that the audio information recorded in the recording medium is reproduced, the audio reproducing device 11 includes a reading device, such as an optical pickup, magnetic head or the like, for reading the audio information from the recording medium and a transforming device, such as a decoder or the like, for transforming the audio information read from the recording medium into sound.

The still picture reproducing device 12 is for performing a so-called “slide show reproduction” by reproducing multiple still picture information units sequentially one by one. The still picture reproducing device 12 reproduces each still picture information unit on the basis of the reproduction control information. As mentioned above, the reproduction control information includes the information for indicating the reproduction starting time point of each still picture information unit to be reproduced during the reproduction of the audio information. For example, the still picture reproducing device 12 recognizes the reproduction starting time point of one still picture information unit on the basis of the reproduction control information, reproduces this still picture information unit at the recognized reproduction starting time point, and then repeats such a process every time each reproduction starting time point arrives. Thus, the multiple still picture information units are reproduced sequentially one by one.

The storing device 13 stores the interruption information, when the reproduction by the audio reproducing device 11 or the still picture reproducing device 12 is interrupted. The storing device 13 includes a device for recognizing the interruption of the reproduction and a memory or the like for storing the interruption information.

The interruption of the reproduction occurs, for example, (i) when a command to stop or pause the reproduction of the audio and still picture is input, (ii) when a command to turn off the power of the information reproducing apparatus 10 is input, (iii) when a command to make the information reproducing apparatus 10 enter a saving mode is input, (iv) when the information reproducing apparatus 10 automatically stops or pauses its reproduction, turns off the power or enters the saving mode.

The interruption information is information for identifying a still picture information unit that is reproduced until the reproduction of the sound and still pictures is interrupted. Namely, it is information for identifying a still picture information unit that is reproduced just at the moment that (or just before) the interruption occurs. The interruption information may be any type of information by which the still picture information unit that is reproduced until the interruption can be identified.

The setting device 14 sets a reproduction resuming position of the audio information, on the basis of the interruption information stored in the storing device 13, in the case that the reproduction by the audio reproducing device 11 or the still picture reproducing device 12 is to be resumed.

“The case that the reproduction is to be resumed” may be (i) the case that a command to resume the reproduction of the audio and still picture information is input, after the reproduction of the audio and still picture information is stopped or paused, (ii) the power of the information reproducing apparatus 10 is turned on, after the power of the information reproducing apparatus 10 is turned off, or (iii) the case that the information reproducing apparatus 10 comes back to a normal mode, after the information reproducing apparatus 10 enters the saving mode.

Further, as mentioned above, the interruption information is information for identifying a still picture information unit that is reproduced until the interruption of the reproduction. Therefore, the setting device 14 can identify a still picture information unit that is reproduced until the interruption, on the basis of the interruption information stored in the storing device 13. Then, the setting device 14 identifies a reproduction position corresponding to a certain time point within a period that the identified still picture information unit is to be reproduced, and sets the reproduction position as the reproduction resuming position of the audio information.

Next, embodiments of the interruption information will be discussed. As mentioned above, the interruption information may be any type of information by which a still picture information unit that is reproduced until the interruption can be identified. Specifically, the interruption information can be configured as follows.

For example, the reproduction control information for a still picture information unit that is reproduced until the interruption may be stored as the interruption information. As mentioned above, the reproduction control information is information by which the reproduction starting position of each still picture information unit is indicated. Therefore, if the reproduction control information for a still picture information unit that is reproduced until the interruption is stored, the still picture information unit that is reproduced until the interruption can be identified on the basis of the reproduction control information, and the reproduction starting position of the still picture information unit can be identified.

Alternatively, designation information to designate the reproduction control information for a still picture information unit that is reproduced until the interruption may be stored as the interruption information. The designation information may be (i) an address on a recording medium at which the reproduction control information for the still picture information unit is recorded, or (ii) a sequence or the number assigned to the reproduction control information for the still picture information unit. If the designation information is stored, the reproduction control information for the still picture information unit that is reproduced until the interruption can be identified, on the basis of the designation information, and then the still picture information unit can be identified further with the reproduction starting time point, on the basis of the reproduction control information.

Alternatively, designation information to designate a still picture information unit that is reproduced until the interruption may be stored as the interruption information. For example, in the case that the reproduction starting time point assigned to each still picture information unit is one point (i.e. the position at which a still picture information unit is reproduced is only one), once the designation information to designate a still picture information unit that is reproduced until the interruption is stored, the still picture information unit can be identified on the basis of the designation information. Further, on the basis of this, the reproduction starting time point of the still picture information unit can be identified.

This configuration of the interruption information as mentioned above allows that a still picture information unit that is reproduced until the interruption can be easily identified, and the reproduction starting time point of the still picture information unit can be also identified. As a result, in the case that the reproduction of the audio information and the still picture information is resumed, the setting device 14 allows that the reproduction starting time point of the still picture information unit, which was reproduced until the interruption, is easily identified, and the reproduction position corresponding to the reproduction starting time point is set as the reproduction resuming position of the audio information.

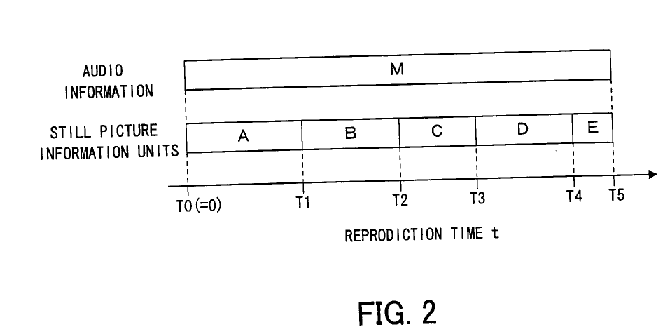

Next, a reproducing operation of the information reproducing apparatus 10 according to the first embodiment will be discussed, with referring to FIG. 2 to FIG. 4.

Firstly, FIG. 2 illustrates a temporal relationship in the reproducing operation between the audio information M and the still picture information units A to E, which are to be reproduced during the reproduction of the audio information M. That is, the lateral axis in FIG. 2 is representative of the reproduction time “t”. Then, when the reproduction time “t” is T0 (T0=0 in FIG. 2), the reproduction of the audio information M is started, and when the reproduction time “t” is T5, the reproduction of the audio information M is terminated. Relating to this, the reproduction of the still picture information unit A is started simultaneously with the start of the reproduction of the audio information M when the reproduction time “t” is T0. Then, when the reproduction time “t” is T1, the still picture information unit to be reproduced is switched from the still picture information unit A to the still picture information unit B. Further, when the reproduction time “t” is T2, the still picture information unit to be reproduced is switched from the still picture information unit B to the still picture information unit C. Similarly, when the reproduction time “t” is T3, the still picture information unit to be reproduced is switched from the still picture information unit C to the still picture information unit D, and when the reproduction time “t” is T4, the still picture information unit to be reproduced is switched from the still picture information unit D to the still picture information unit E. Then, when the reproduction time “t” reaches T5, the reproduction of the still picture information unit E is terminated simultaneously with the termination of the reproduction of the audio information M.

The following example is discussed about the case that the information reproducing apparatus 10 reads (i) the audio information M, (ii) the still picture information units A to E, and (iii) the reproduction control information to indicate, respectively, the reproduction starting time points T0 to T4 of the still picture information units A to E from a recording medium, such as a DVD or the like, in which these kinds of information is recorded.

In this case, once the recording medium is loaded into the information reproducing apparatus 10 and the user inputs a command to start the reproduction, the audio reproducing device 11 in the information reproducing apparatus 10 starts the reproduction of the audio information M (t=T0=0). At this time, since the reproduction starting time point of the still picture information unit A is T0, the still picture reproducing device 12 starts the reproduction of the still picture information unit A on the basis of the reproduction control information. As a result, the reproduction of the audio information M and the reproduction of the still picture information unit A are started at the same time.

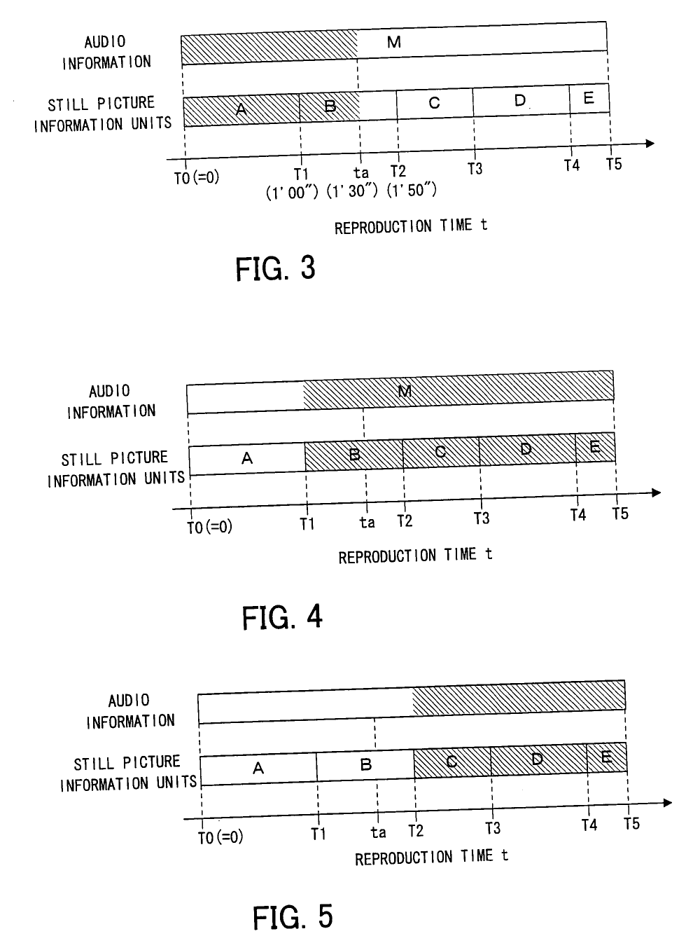

Next, FIG. 3 shows a condition after the reproduction of both the audio information M and the still picture information units A to E, as seen in FIG. 2, is started. That is, the diagonally shaded part in FIG. 3 is representative of the part about which the reproduction is actually performed.

As shown in FIG. 3, once the reproduction of the audio information M and the still picture information unit A is started and the reproduction time “t” reaches the reproduction starting time point T1 of the still picture information unit B, the still reproducing device 12 switches the still picture information unit to be reproduced from the still picture information unit A to the still picture information unit B.

Further, as shown in FIG. 3, if the user inputs a command to turn off the power into the information reproducing apparatus 10, at a time point “ta” (e.g. 1′30″) which is after the reproduction starting time point T1 (e.g. 1′00″) of the still picture information unit B and before the reproduction starting time point T2 (e.g. 1′50″), the audio reproducing device 11 and the still picture reproducing device 12 stop or interrupt the reproduction of the audio information M and the still picture information unit B, respectively.

Further, at this time, the storing device 13 stores information, such as a numeral value to indicate the reproduction starting time point of the still picture information unit B, for identifying the still picture information unit B, which is reproduced until the interruption, into a memory or the like. This information is the interruption information. Then, the power of the information reproducing apparatus 10 is turned off. Incidentally, the interruption information stored in the storing device 13 still remains, even if the power of the information reproducing apparatus 10 is turned off.

Next, FIG. 4 shows a condition that the reproduction of the audio information M and the still picture information units shown in FIG. 2 is resumed, by turning on the power of the information reproducing apparatus 10 once after the power of the information reproducing apparatus 10 is turned off. That is, the diagonally shaded part in FIG. 4 is representative of the part about which the reproduction is resumed.

As shown in FIG. 4, if the user turns on the power of the information reproducing apparatus 10, once after the power of the information reproducing apparatus 10 is turned off, and inputs a command to resume the reproduction of the audio information M and the still picture information units into the information reproducing apparatus 10, the setting device 14 sets the reproduction resuming position of the audio information M, on the basis of the interruption information stored in the storing device 13. That is, in this example, the information stored as the interruption information in the storing device 13 is a numeral value to indicate the reproduction starting time point T1 of the still picture information unit B. Therefore, the setting device 14 identifies the reproduction position of the audio information M corresponding to the reproduction starting time point T1, and sets the reproduction position as the reproduction resuming position of the audio information M. As a result, the audio reproducing device starts the reproduction of the audio information M from a position corresponding to the time point T1, and at the same time, the still picture reproducing device 12 starts the reproduction of the still picture information unit B from the point corresponding to the time point T1.

Thus, according to the information reproducing apparatus 10 of the first embodiment, if the reproduction is interrupted, then the information to identify a still picture information unit that is reproduced until the interruption is stored as the interruption information, and if the reproduction is to be resumed, then the reproduction resuming position of the audio information is set on the basis of the interruption information which is already stored. Thereby, the reproduction can be resumed from a position at which the reproduction is interrupted or from a vicinity of the position, even if the reproduction is interrupted. Thereby, the user can enjoy the part of the music composition continued from the interrupted position, without any operation or with a simple operation, even if the reproduction of the music composition is once interrupted.

Further, the configuration that the reproduction position corresponding to the reproduction starting time point of a still picture information unit which is reproduced until the interruption is set to the reproduction resuming position of the audio information allows that the reproduction resuming position of the audio information is coincided with a switching point at which a still picture information unit is switched to another unit. Certainly, according to an example shown in FIG. 3 and FIG. 4, as a result, the reproduction resuming position (T1 in FIG. 4) is deviated from the reproduction interrupted position (“ta” in FIG. 3). Nevertheless, the user can enjoy the still picture information unit B which is reproduced from the start of the content when resumed, owing to setting the reproduction resuming position to coincide with a position at which the still picture information unit A is switched to the still picture information unit B. That is, if the reproduction is resumed from the interrupted position “ta”, a period that the still picture information unit B is reproduced when the reproduction is resumed, becomes short. In that case, the user cannot enjoy or watch the still picture information unit B comfortably. On the contrary, as in the embodiment of the present invention, the user can enjoy or watch the still picture information unit B comfortably, because the still picture information unit B is reproduced from its beginning by setting the reproduction resuming position to the time point T1 even if the interrupted position is “ta”.

On the other hand, the switching time point of the still picture information unit is set to a “tone changing point” of the music composition or a point at which the music composition is changed to the next one, the reproduction of the music composition is resumed from the “tone changing point” of the music composition or the point at which the music composition is changed to the next one. Therefore, the user can enjoy or listening to the music composition comfortably, after the reproduction is resumed.

Next, variants of the information reproducing apparatus 10 according to the first embodiment will be discussed.

If the audio information comprises multiple units of audio information (audio information units) and the reproduction control information is for indicating the reproduction starting time point of multiple still picture information units to be reproduced during the reproduction of any one of or each of the audio information units, the storing device 13 may be designed to store, in addition to the interruption information, unit designation information to designate an audio information unit that is reproduced until the interruption, while the setting device 14 may be designed to set the reproduction resuming position of an audio information on the basis of the interruption information and the unit designation information stored in the storing device 13, when the reproduction is to be resumed by the audio reproducing device 11 and the still reproducing device 12.

For example, assume that the audio information comprises multiple audio information units such as multiple tracks or groups. In this case, the reproduction control information may be configured to indicate the reproduction starting time point of each still picture information units to be reproduced during the reproduction of any one of or each of audio information units. In such a case, the storing device 13 stores the unit designation information to designate an audio information unit that is reproduced until the interruption and the interruption information to identify the still picture information unit that is reproduced until the interruption. Then, the setting device 14 sets the reproduction resuming position of the audio information on the basis of these information stored in the storing device 13.

Thereby, it is possible to reproduce the audio information from the position at which its reproduction is interrupted, even in the case that the audio information comprises multiple audio information units such as multiple tracks or groups.

(Second Embodiment)

The second embodiment of the present invention will now be discussed, with referring to FIG. 1, FIG. 2, FIG. 3 and FIG. 5.

The information reproducing apparatus according to the second embodiment is provided with an audio reproducing device, a still picture reproducing device, a storing device and a setting device, similar to the information reproducing apparatus 10 according to the first embodiment (FIG. 1). In the information reproducing apparatus according to the second embodiment, each fundamental construction of the audio reproducing device, the still picture reproducing device and the setting device, respectively, is same as those of the information reproducing apparatus 10 according to the first embodiment. Hence, the following discussion is focused on the storing device.

The storing device of the information reproducing apparatus according to the second embodiment stores information to identify a still picture information unit to which a reproduction starting time point nearest to an interruption time point is assigned, in the case that the reproduction by the audio reproducing device and the still picture reproducing device is interrupted.

That is, the interruption information for the information reproducing apparatus according to the second embodiment is information to identify a still picture information unit to which the reproduction starting time point nearest to the interruption time point is assigned.

The operation of the information reproducing apparatus according to the second embodiment that is constructed as mentioned above will now be discussed, with referring to FIG. 2, FIG. 3 and FIG. 5.

Firstly, assume a case that a recording medium in which audio information M, still picture information units A to E and reproduction control information to indicate reproduction starting time points T0 to T4 of the still picture information units A to E are recorded, as shown in FIG. 2, is reproduced in the information reproducing apparatus according to the second embodiment.

In this case, as shown in FIG. 3, each reproduction of the audio information M and the still picture information unit A is started from a reproduction time T0 (t=0). Then, when the reproduction time “t” reaches a reproduction starting time point T1 of the still picture information unit B, the still picture information unit A is switched to the still picture information unit B.

Next, as shown in FIG. 3, if a user inputs a command to turn off the power into the information reproducing apparatus, at a time point “ta”, which is after the reproduction starting time point T1 (e.g. 1′30″) of the still picture information unit B and before a reproduction starting time point T2 (e.g. 1′50″) of the still picture information unit C, then each reproduction of the audio information and the still picture information unit B is interrupted at the time point “ta”.

Further, at this time, the storing device stores, as interruption information, information to identify a still picture information unit to which a reproduction starting time point nearest to the interruption time point “ta” is assigned. That is, in FIG. 3, the still picture information unit, to which the reproduction starting time point nearest to the interruption time point “ta” is assigned, is the still picture information unit C, to which the reproduction starting time point T2 is assigned. Therefore, the storing device stores, as the interruption information, the information to identify the still picture information unit C. For instance, the storing device stores a numeral value to indicate the reproduction starting time point T2. Then, the power of the information reproducing apparatus is turned off. Incidentally, the interruption information stored by the storing device still remains even in the case that the power of the information reproducing apparatus is turned off.

Now, FIG. 5 shows a condition that the reproduction of the audio information M and the still picture information units, shown in FIG. 2, is resumed by turning on the power of the information reproducing apparatus, once after the power of the same is turned off. That is, the diagonally shaded part in FIG. 5 is representative of a part about which the reproduction is resumed.

As shown in FIG. 5, if the user turns on the power of the information reproducing apparatus once after the power of the same is turned off, and inputs a command to resume each reproduction of the audio information M and the still picture information units, the setting device sets the reproduction resuming position of the audio information M, on the basis of the interruption information stored by the storing device. That is, in this example, the information stored as the interruption information by the storing device is the numeral value to indicate the reproduction starting time point T2 of the still picture information unit C. Therefore, the setting device sets, as the reproduction resuming position of the audio information M, a reproduction position corresponding to the reproduction starting time point T2. As a result, the audio reproducing device resumes the reproduction of the audio information M from a position corresponding to the time point T2, while the still picture reproducing device starts the reproduction of the still picture information unit C from the time point T2.

Thus, according to the information reproducing apparatus of the second embodiment, in the case that the reproduction is interrupted, the interruption information to identify a still picture information unit, to which the reproduction starting time point nearest to the interruption time point is assigned, is stored, while in the case that the reproduction is to be resumed, the reproduction resuming position of the audio information is set on the basis of the interruption information, which is already stored. Therefore, it is possible to resume the reproduction from a position at which the reproduction is interrupted or from a vicinity of the position, even in the case that the reproduction is interrupted. Thereby, the user can enjoy the part of the music composition continued from the interrupted position, without any operation or with a simple operation, even if the reproduction of the music composition is interrupted.

Further, the construction in which a still picture information unit, to which the reproduction starting time nearest to the interrupted time point is assigned, is identified, and the reproduction position corresponding to the reproduction starting time point of the still picture information unit is set as the reproduction resuming position of the audio information allows that the reproduction resuming position of the audio information is coincide with the switching point of the still picture information. Certainly, according to the example in FIG. 3 and FIG. 5, as a result, the reproduction resuming position (T2 in FIG. 5) is deviate from the reproduction interruption position (“ta” in FIG. 3). Nevertheless, this coincidence between the reproduction resuming position and the position corresponding to the reproduction starting time point of the still picture information allows the user to enjoy the still picture information from the switching point of the still picture information when the reproduction is resumed. That is, if the reproduction is resumed from the interruption time point “ta”, the still picture information unit B is switch to the still picture information unit C, immediately after the reproduction is resumed. In this case, the user cannot enjoy or watch the still picture comfortably. In the present embodiment, however, the user can enjoy or watch the still picture comfortably, because the reproduction is resumed from the beginning of the still picture information unit C, owing to resuming the reproduction from the time point T2 nearest to the interruption time point “ta”, which is not coincide with the T2. On the other hand, the time point at which the still picture information is switched is set to the “tone changing point” of the music composition or a point at which the music composition is changed to the next one, the reproduction of music is resumed from the “tone changing point” of the music composition or the point at which the music composition is changed to the next one. Therefore, the user can enjoy or listen to the music comfortably after the reproduction is resumed.

Now, variants of the information reproducing apparatus according to the second embodiment will be discussed.

In the case that the audio information comprises multiple audio information units, and the reproduction control information indicates each reproduction starting time point of multiple still picture information units to be reproduced during the reproduction of any of or each of the audio information units, the storing device may be designed to store, in addition to the interruption information, the unit designation information to designate an audio information unit that is reproduced until the interruption, if the audio reproduction device and the still picture reproducing device interrupt or stop the reproduction, while the setting device may be designed to set the reproduction resuming position an audio information unit on the basis of the interruption information and the unit designation information stored in the storing device, if the audio reproducing device and the still picture reproducing device resume the reproduction.

Thereby, the reproduction can be resumed from the previously interrupted position or from a vicinity of the position, even in the case that the audio information comprises multiple groups or tracks.

(Third Embodiment)

The third embodiment of the present invention will now be discussed, with referring to FIG. 1 to FIG. 4.

The information reproducing apparatus according to the third embodiment is provided with, similar to the information reproducing apparatus 10 (FIG. 1) according to the first embodiment, an audio reproducing device, a still picture reproducing device, a storing device and a setting device. The fundamental construction of the audio reproducing device and the still picture reproducing device in the information reproducing apparatus according to the third embodiment is same as that of the information reproducing apparatus 10 according to the first embodiment. Hence, the following discussion is focused on the storing device and the setting device.

The storing device in the information reproducing apparatus according to the third embodiment stores, as interruption information, information to indicate the interruption time point, in the case that the reproduction by the audio reproducing device and the still picture reproducing device is interrupted. For instance, in the example shown by FIG. 2 and FIG. 4, the storing device stores, as interruption information, a numeral value to indicate the interruption time point “ta” (e.g. 1′30″) into a memory or the like.

Then, in the case that the reproduction by the audio reproducing device and the still picture reproducing device is to be resumed, the setting device identifies a still picture information unit that is reproduced until the interruption on the basis of the interruption information stored in the storing device and sets the reproduction resuming position of the audio information on the basis of the still picture information unit.

For instance, the setting device identifies a still picture information unit which is reproduced until the interruption on the basis of the interruption information, and sets a reproduction position corresponding to any one time point within a period wherein the still picture information unit is to be reproduced.

According to the information reproducing apparatus of the third embodiment having the above-mentioned structure, the reproduction can be also resumed from a position at which the reproduction is previously interrupted or from a vicinity of the position.

Now, variants of the information reproducing apparatus according to the third embodiment will be discussed.

In the case that the audio information comprises multiple audio information units, and the reproduction control information indicates each reproduction starting time point of multiple still picture information units to be reproduced during the reproduction of any one of or each of the multiple audio information units, the storing device may be designed to store, in addition to the interruption information, the unit designation information to designate an audio information unit that is reproduced until the interruption, if the audio reproduction device and the still picture reproducing device interrupt or stop the reproduction, while the setting device may be designed to identify an audio information unit which is reproduced until the interruption on the basis of the unit designation information stored in the storing device, identify a still picture information unit that is reproduced until the interruption on the basis of the interruption information stored in the storing device and set the reproduction resuming position of an audio information unit on the basis of the interruption information and the unit designation information stored in the storing device, if the audio reproducing device and the still picture reproducing device is to resume the reproduction.

Thereby, the reproduction can be resumed from a position at which the reproduction is previously interrupted or from a vicinity of the position, even in the case that the audio information comprises multiple groups or tracks.

Alternatively, in the information reproducing apparatus according to the third embodiment, the setting device may be designed to set a reproduction position of the audio information corresponding to the reproduction starting time point of a still picture information unit that is reproduced until the interruption as a reproduction resuming position of the audio information, on the basis of the interruption information stored in the storing device.

Thereby, the reproduction of the audio information can be resumed from the switching point of the still picture information.

(Fourth Embodiment)

The fourth embodiment of the present invention will now be discussed, with referring to FIG. 2, FIG. 3 and FIG. 5.

The information reproducing apparatus according to the fourth embodiment is provided with, similar to the information reproducing apparatus according to the second embodiment, an audio reproducing device, a still picture reproducing device, a storing device and a setting device. In the information reproducing apparatus according to the fourth embodiment, the fundamental construction of the audio reproducing device and the still picture reproducing device is same as that of the information reproducing apparatus according to the second embodiment. Hence, the following discussion is focused on the storing device and the setting device.

The storing device in the information reproducing apparatus according to the fourth embodiment stores, as interruption information, information to indicate the interrupted time point, in the case that the reproduction by the audio reproducing device and the still picture reproducing device is interrupted. For instance, in the example shown in FIG. 2, FIG. 3 and FIG. 5, the storing device stores, as the interruption information, a numeral value to indicate the interrupted time point “ta” (e.g. 1′30″) into a memory or the like.

Then, the setting device identifies a still picture information unit, to which a reproduction starting time point nearest to the interrupted time point is assigned, on the basis of the interruption information stored in the storing device, and identifies a reproduction resuming position, on the basis of the still picture information unit, in the case that the reproduction by the audio reproducing device and the still picture reproducing device is to be resumed.

For instance, the setting device identifies a still picture information unit, to which a reproduction starting time point nearest to the interrupted time point is assigned, on the basis of the interruption information, and sets a reproduction position corresponding to any one time point within a period wherein the still picture information unit is to be reproduced.

According to the information reproducing apparatus of the fourth embodiment having the above-mentioned structure, the reproduction can be also resumed from a position at which the reproduction is previously interrupted or from a vicinity of the position.

Now, variants of the information reproducing apparatus according to the fourth embodiment will be discussed.

In the case that the audio information comprises multiple audio information units, and the reproduction control information indicates each reproduction starting time point of multiple still picture information units to be reproduced during the reproduction of any one of or each of the audio information units, the storing device may be designed to store, in addition to the interruption information, unit designation information to designate an audio information unit that is reproduced until the interruption, if the reproduction by the audio reproduction device and the still picture reproducing device is interrupted, while the setting device may be designed to identify an audio information unit which is reproduced until the interruption on the basis of the unit designation information stored in the storing device, identify a still picture information unit which is reproduced until the interruption on the basis of the interruption information stored in the storing device, identify the still picture information, to which a reproduction starting time point nearest to the interruption time point is assigned, on the basis of the interruption information stored in the storing device and set the reproduction resuming position of an audio information unit on the basis of the interruption information and the unit designation information, if the reproduction by the audio reproducing device and the still picture reproducing device is to be resumed.

Thereby, the reproduction can be resumed from a position at which the reproduction is previously interrupted or from a vicinity of the position, even in the case that the audio information comprises multiple groups or tracks.

Alternatively, in the information reproducing apparatus according to the fourth embodiment, the setting device may be designed to identify the reproduction starting time point of a still picture information unit, to which the reproduction starting time point nearest to the interruption time point is assigned, on the basis of the interruption information stored in the storing device, and set a reproduction position of the audio information corresponding to the reproduction starting time point of the still picture information unit as a reproduction resuming position of the audio information.

Thereby, the reproduction of the audio information can be resumed from the switching point of the still picture information.

Incidentally, embodiments mentioned above may be embodied in a special designed device or component integrated within hardware or may be embodied by making a computer read a program.

### EXAMPLES

Now, examples of the present invention will be discussed, with referring to drawings. In the following examples, the information reproducing apparatus of the present invention is applied to a DVD audio player.

### First Example

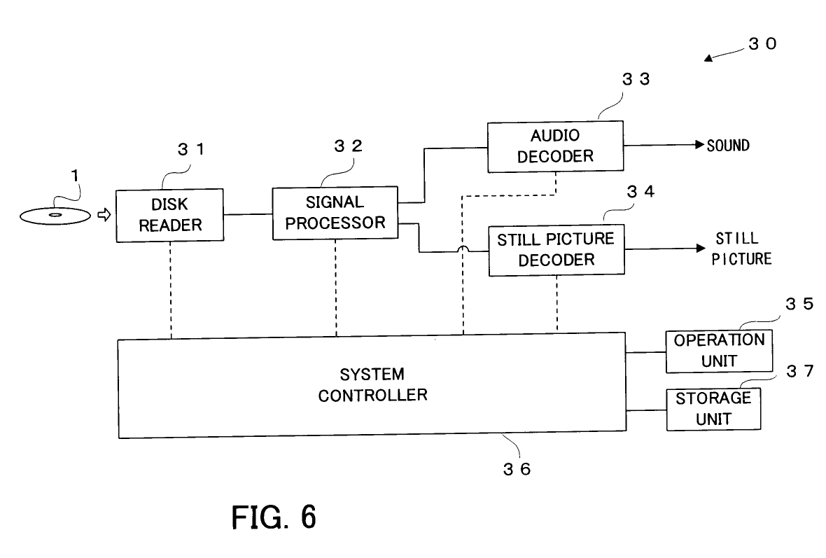

The first example of the present invention will now be discussed, with referring to FIG. 6 to FIG. 10.

Firstly, a construction of a DVD audio player according to the first example will be discussed. FIG. 6 shows the construction of the DVD audio player according to the first example. As shown in FIG. 6, the DVD audio player 30 according to the first example is an information reproducing apparatus for reproducing audio information and still picture information units recorded in a DVD 1. The audio information may be information obtained by encoding music, and the still picture information units may be information obtained by encoding still pictures. The DVD audio player 30 has a function to reproduce the still picture information units during the reproduction of the audio information, i.e. a function to perform a so-called “slide show reproduction”.

The DVD audio player 30 is provided with a disk reader 31, a signal processor 32, an audio decoder 33, a still picture decoder 34, an operation unit 35, a system controller 36 and a storage unit 37.

The disk reader 31 includes an optical pickup for irradiating a light beam onto a recording surface of the DVD 1 and receiving the reflection light, a spindle motor for rotating the DVD 1, and a servo control mechanism for controlling an irradiation spot of the light beam and the rotation of the spindle motor, although any of which is not shown. The disk reader 31 is operative to read a signal including the audio information and the still picture information recorded in the DVD 1 and to output the read signal to the signal processor 32.

The signal processor 32 includes a decoder circuit or the like. The signal processor 32 is operative to decode the signal output from the disk reader 31, and to extract the audio information, the still picture information units and control information or the like to control the reproduction of these kinds of information. Then each of the audio information and the still picture information units is supplied to the audio decoder 33 and the still picture decoder 34, respectively.

The audio decoder 33 is a circuit for decoding the audio information. The audio signal decoded by the audio decoder 33 is supplied to a speaker or the like, for example via a D/A converter (digital-analog converter).

The still picture decoder 34 is a circuit for decoding the still picture information. The still picture signal decoded by the still picture decoder 34 is supplied to a monitor, such as an LCD, a PDP or the like.

The operation unit 35 includes a switch panel, a remote controller or the like. The operation unit 35 serves as a user interface for inputting a command of turning on/off the power, resuming the reproduction, stopping the reproduction and so on, into the DVD audio player 30.

The system controller 36 includes a processing circuit and a storage circuit, such as a CPU (Central Processing Unit), a ROM (Read Only Memory), a RAM (Random Access Memory) or the like. The system controller 36 is for a general control of the DVD audio player 30, a reproduction control, a reproduction interruption control, a reproduction resuming control or the like.

The storage unit 37 is formed of a recordable non-volatile memory. The storage unit 37 is for storing information, which is necessary to the control or processing in the system controller 36 and which is necessary to be stored even in the case that the power of the DVD player 30 is turned off.

Now, the audio information, the still picture information units and the control information to control the audio information and the still picture information units will be discussed.

In compliance with a DVD standard, the audio information, the still picture information units and the control information to control the audio information and the still picture information units are recorded in the DVD 1. The audio information has a hierarchical structure generally made of groups, audio titles and tracks. One group is made of multiple audio titles. One audio title is made of a program chain, including multiple programs. Each track corresponds to each program defined by the program chain.

The user can designate the group and the track, when the DVD 1 is reproduced. The user designates one group, and further designates one track belonged to the group, the audio information (AOB: Audio Object) and the still picture information (ASVOB: Audio Still Video Object), which are associated with the track (program), is reproduced, on the basis of the program chain information.

In the DVD standard, although there are various ways to reproduce the still picture information units with the audio information, the selection, i.e. which way is to be selected, is decided by a supplier of the audio information and the still picture information units. The supplier selects a way of reproducing the still picture information units and records the selected way as the control information into the DVD 1. Thereby, the DVD audio player 30 reads the control information and reproduces the still picture information units according to the way recorded in the control information.

As a way of reproducing the still picture information units, there is a slide show reproduction. The slide show reproduction is a way of reproducing (displaying) multiple still pictures one by one at a predetermined time interval. In the present example, the supplier of the information recorded in the DVD 1 selects the slide show reproduction as the way of reproducing the still picture information, which is recorded as the control information in the DVD 1.

To perform the slide show reproduction of the still pictures, multiple still picture information units corresponding to multiple still pictures as well as the display list information (reproduction control information) including each reproduction starting time of each still picture information unit are recorded in the DVD 1. The display list information can be produced and recorded for each track.

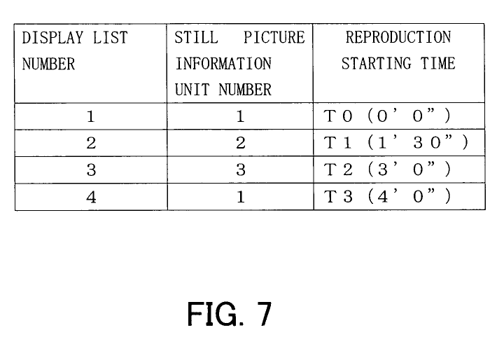

FIG. 7 shows an example of the display list information. In this example, for convenience of explanation, as a simple concrete example, it is assumed that the display list DL as shown in FIG. 7 is produced in the track #1 of the group #1 and recorded in the DVD 1.

As shown in FIG. 7, four display lists relating to the still picture information units to be reproduced (displayed) during the reproduction of the track #1 is recorded in the order to be reproduced, in the display list DL. Each display list includes a display list number (the first row in FIG. 7), a still picture information unit number (the second row) and a reproduction starting time (the third row).

The display list number is for indicating a reproduction order of each display list (a reproduction order of a still picture information unit designated in each display list) and for identifying each display list. The still picture information unit number is a number for designating a still picture information unit to be reproduced during the reproduction of the track #1. The reproduction starting time is a reproduction starting time of each still picture information unit to be reproduced during the reproduction of the track #1. Incidentally, multiple still picture information units to be reproduced during the reproduction of the audio information may be different from each other, or may be overlapped fully or partially from each other. In the example shown in FIG. 7, a still picture information unit to be reproduced firstly is overlapped with (i.e. the same as) a still picture information unit to be reproduced fourthly.

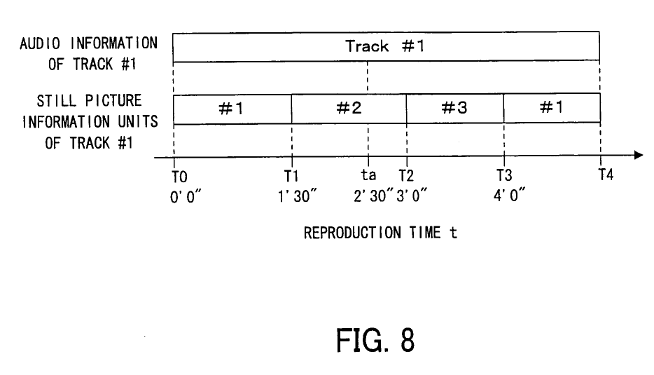

FIG. 8 shows a temporal relationship between the audio information associated with the track #1 and the still picture information units #1 to #4 associated with the track #1, when they are reproduced. If the track #1 is reproduced, the audio information and the still picture information units associated with the track #1 are reproduced as shown in FIG. 8.

That is, a lateral axis in FIG. 8 is representative of the reproduction time “t”. When the reproduction time “t” is T0 (T0 is zero in FIG. 8), the reproduction of the audio information is started, and when the reproduction time “t” is T4, the reproduction of the audio information is terminated. On the other hand, when the reproduction time “t” is T0, the reproduction of the still picture information unit #1 is started, simultaneously with the start of the reproduction of the audio information. Further, when the reproduction time “t” is T1 (1′30″), the still picture information unit to be reproduced is switched from #1 to #2. Further, when the reproduction time “t” is T2 (3′00″), the still picture information unit to be reproduced is switched from #2 to #3. Similarly, when the reproduction time “t” is T3 (4′00″), the still picture information unit to be reproduced is switched from #3 to #1 (the still picture information unit #1 corresponding to the display list number #4 in FIG. 7). Finally, when the reproduction time “t” reaches T4, the reproduction of the still picture information unit #1 is terminated, simultaneously with the termination of the reproduction of the audio information.

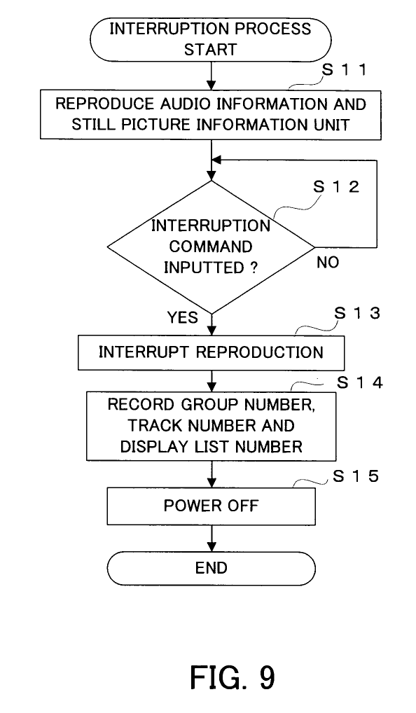

Now, a reproduction interruption process in the DVD audio player 30 will be discussed, with referring to FIG. 9.

FIG. 9 shows a reproduction interruption process. The reproduction interruption process is a process that is executed when the reproduction is interrupted during the reproduction of the audio information and the still picture information units. There are many cases where the reproduction is interrupted, this example takes a case where a user inputs a command to turn off the power of the DVD audio player 30. Incidentally, the reproduction interruption process is executed under control of the system controller 36.

As shown in FIG. 9, the system controller 36 starts the reproduction of the audio information and the still picture information units (step S11), and then determines whether or not a command to interrupt the reproduction is input (step S12).

If the user inputs a command to turn off the power of the DVD audio player 30 via the operation unit 35, the system controller 36 receives this instruction (step S12: YES), and interrupts the reproduction of the audio information and the still picture information unit (step S13).

Next, the system controller 36 records (i) a track number with a group number, which are reproduced until the interruption (as unit designation information), and (ii) a display list number corresponding to a still picture information unit, which is reproduced until the interruption (as interruption information), in the storage unit 37 (step S14).

Then, the system controller 36 turns off the power of the DVD audio player 30 (step S15). Incidentally, since the storage unit 37 is made of a non-volatile memory, the group and track numbers and the display list number, which are recorded in the storage unit 37, are maintained, even if the power of the DVD audio player 30 is turned off.

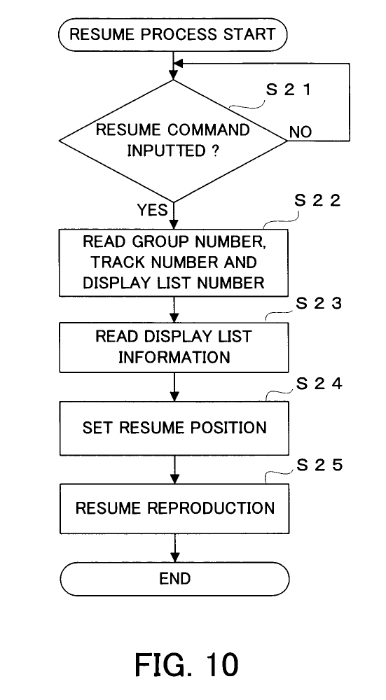

Now, a reproduction resuming process in the DVD audio player 30 will be discussed, with referring to FIG. 10.

FIG. 10 shows a reproduction resuming process. The reproduction resuming process is a process that is executed when the reproduction is resumed once after that the reproduction of the audio information with the reproduction of the still picture information unit is interrupted. There are many cases that the reproduction is resumed, and this example takes a case that a user turns on the power of the DVD audio player 30 and inputs a command to resume the reproduction into the same, once after that the user turns off the power of the same. Incidentally, the reproduction resuming process is executed under control of the system controller 36.

As shown in FIG. 10, once the power of the DVD audio player 30 is turned on, the system controller 36 determines whether or not a command to resume the reproduction is input (step S21).

If the user inputs the command to resume the reproduction via the operation unit 35, the system controller 36 receives the instruction (step S21:YES), and then reads the group and track numbers, and the display list number, which are recorded in the storage unit 37 (step S22).

Next, the system controller 36 reads, from the DVD 1, display list information associated with the track (program) that is identified by the group and track numbers read from the storage unit 37 (step S23).

Next, the system controller 36 sets a reproduction resuming position of the audio information and the still picture information unit, on the basis of the group number, the track number, the display list number and the display list information that is read from the DVD 1 (step S24). Specifically, a track to be reproduced is identified by employing the group number and the track number, which are read from the storage unit 37. Next, a reproduction starting time of a still picture information unit that is reproduced until the interruption, by employing the display list number read from the storage unit 37 and the display list information read from the DVD 1. Then, a reproduction position corresponding to the reproduction starting time of the still picture information unit is set as a reproduction resuming position of the track (the audio information and the still picture information unit associated with the track).

Then the system controller 36 resumes the reproduction of the audio information and the still picture information unit from the reproduction resuming position that is set in the above-mentioned manner (step S25).

Next, the specific operation and effect according to the above-mentioned reproduction interruption process and the reproduction resuming process will be discussed, with referring to FIG. 7 and FIG. 8.

As shown in FIG. 8, it is assumed that the DVD audio player 30 starts the reproduction of the track #1. Then, firstly, when the reproduction time “t” is T0 (0′00″), the reproduction of the audio information associated with the track #1 is started, and at the same time, the still picture information unit #1 associated with the track #1 is reproduced. That is, the display list information DL associated with the track #1 is referred by the system controller 36, and the reproduction of the still picture information unit #1 designated in the display list #1 is started at the reproduction time T0.

Next, when the reproduction time “t” reaches T1 (1′30″), the still picture information unit to be reproduced is switched from #1 to #2. That is, the system controller 36 checks the display list information DL and reproduces the still picture information unit #2 designated in the display list #2 at the reproduction starting time T1.

After that, if the user inputs a command to turn off the power of the DVD audio player 30 into the same, at a time point “ta” (e.g. 2′30″) before the reproduction time reaches T2 (3′ 00″), then the reproduction of the audio information and the reproduction of the still picture information unit are interrupted. Next, numerals “1” for the group that is reproduced until the interruption, “1” for the track that is reproduced until the interruption, and “2” as the display list number corresponding to a still picture information unit reproduced until the interruption, are recorded into the storage unit 37. Then, the power of the DVD audio player 30 is turned off.

After a while, if the user turns on the power of the DVD audio player 30 and inputs a command to resume the reproduction, firstly the group number “1”, the track number “1” and the display list number “2”, which are stored in the storage unit 37, are read, and then the display list information DL (FIG. 7) is read from the DVD 1, on the basis of the group number “1” and the track number “1”.

Next, as shown in FIG. 7, the display list #2 in the display list information DL is checked and the reproduction starting time T1 (1′30″) of the still picture information unit #2 designated in the display list #2 is identified. Then, on the basis of the group number “1” and the track number “1”, the track #1 is identified as the track whose reproduction is to be resumed, and a reproduction position corresponding to the reproduction starting time T1 is set as the reproduction resuming position.

As a result, the reproduction of the audio information with the reproduction of the still picture information unit is resumed from the time point T1 shown in FIG. 8.

As discussed above, according to the information reproducing apparatus 10 of the first embodiment, if the reproduction is interrupted, the group number and the track number reproduced until the interruption and the display list number corresponding to a still picture information unit reproduced until the interruption are stored, and if the reproduction is resumed, the track whose reproduction is to be resumed and its reproduction resuming position are identified on the basis of the group number and the track number and the display list number, all of which are stored. Therefore, the reproduction can be resumed from the position at which the reproduction is interrupted or from a vicinity of the position, even after that the reproduction is interrupted. Thereby, the user can enjoy a continuous part of the music without any special manipulation, or with a simple manipulation, even after that the reproduction of the music is once interrupted.

Further, since the reproduction position corresponding to the reproduction starting time of a still picture information unit that is reproduced until the interruption is set as the reproduction resuming position of the track, the reproduction resuming position of the track can be coincide with the still picture switching point. Thereby, a still picture information unit is reproduced always from the beginning i.e. the reproduction starting time point, when the reproduction is resumed. Therefore, the user can enjoy the still pictures comfortably.

On the other hand, the still picture switching point is set to a changing point from one music composition to another music composition (hereinafter referred to as a “music composition changing point”) or a tone changing point in a music composition, the reproduction of the music is resumed from the music composition changing point or the tone changing point. Therefore, the user can enjoy or listen to the music comfortably after resuming the reproduction.

Additionally, since the group number, the track number and the display list number are stored, when the reproduction is interrupted, a volume of data to be stored is decreased, and the storing process is remarkably simplified and facilitated. Further, the reading process when the reproduction is resumed is remarkably simplified and facilitated. Therefore, the reproduction interruption process and the reproduction resuming process can be executed promptly.

### Second Example

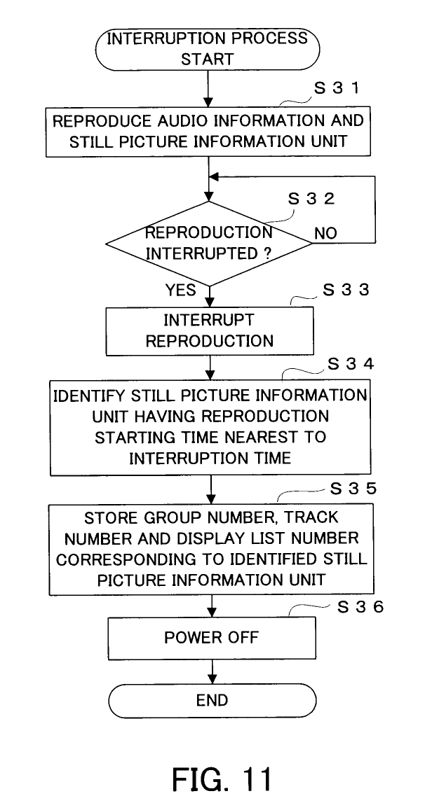

The second example of the present invention will now be discussed, with referring to FIG. 11. Incidentally, in the second example, the same components as those in the first example carry the same reference numerals, and the explanations thereof are omitted as appropriate.

The DVD audio player according to the second example is of the same construction as the DVD audio player 30 according to the first example, except for the reproduction interruption process. Therefore, the following discussion is focused on the reproduction interruption process.

FIG. 11 shows the reproduction interruption process in the DVD audio player according to the second example.

As shown in FIG. 11, the system controller 36 starts the reproduction of the audio information and the still picture information unit (step S31), and then determines whether or not a command to interrupt the reproduction is input (step S32).

If a user inputs a command to turn off the power of the DVD audio player via the operation unit 35, the system controller 36 receives this instruction (step S32: YES), and interrupts the reproduction of the audio information and the still picture information unit (step S33).

Next, the system controller 36 identifies a still picture information unit to which a reproduction starting time nearest to the interruption time point is assigned (step S34). For instance, assuming that a numeral “N1” is representative of the interruption time point and a numeral “N2” is representative of a reproduction starting time of a still picture information unit that is reproduced until the interruption, a numeral “N3” is obtained by subtracting “N2” from “N1”. Similarly, assuming that a numeral “N4” is representative of a reproduction starting time of another still picture information unit that is to be reproduced next to the still picture information unit that is reproduced until the interruption, a numeral “N5” is obtained by subtracting “N1” from “N4”. Comparing “N3” with “N5”, in the case that “N3” is not more than “N5”, the still picture information unit that is reproduced until the interruption is identified as the still picture information unit to which the reproduction starting time nearest to the interruption time point is assigned. On the other hand, in the case that “N3” is more than “N5”, said another still picture information unit that is to be reproduced next to the still picture information unit that is reproduced until the interruption is identified as the still picture information unit to which the reproduction starting time nearest to the interruption time point is assigned.

Next, the system controller 36 stores the group and track numbers, which is reproduced until the interruption (as unit designation information), the display list number corresponding to a still picture information unit, to which the reproduction starting time nearest to the interruption time point is assigned (as interruption information), into the storage unit 37 (step S35).

Then, the system controller 36 turns off the power of the DVD audio player (step S36).

Next, the specific operation and effect in the reproduction interruption process and the reproduction resuming process of the DVD audio player according to the second example will be discussed, with referring to FIG. 7 and FIG. 8.

As shown in FIG. 8, it is assumed that the DVD audio player 30 starts the reproduction of the track #1. Then, firstly, when the reproduction time “t” is T0 (0′00″), the reproduction of the audio information associated with the track #1 is started, and at the same time, the still picture information unit #1 associated with the track #1 is reproduced.

Next, when the reproduction time “t” reaches T1 (1′30″), the still picture information unit to be reproduced is switched from #1 to #2.

After that, if the user inputs a command to turn off the power of the DVD audio player, at a time point “ta” (e.g. 2′30″) before the reproduction time reaches T2 (3′ 00″), then the reproduction of the audio information with the reproduction of the still picture information unit is interrupted.

Next, a still picture information unit to which the reproduction starting time nearest to the interruption time point “ta” is assigned is identified. For instance, if the interruption time point is 2′30″, the reproduction starting time nearest to the interruption time point is T2 (3′00″). Therefore, the still picture information unit #3 designated in the display list #3 is identified as the still picture information unit to which the reproduction starting time nearest to the interruption time point “ta” is assigned.

A numeral “1” as for the group number that is reproduced until the interruption as well as a numeral “1” as for the track number and a numeral “3” as for the display list number corresponding to the still picture information unit to which the reproduction starting time nearest to the interruption time point “ta” is assigned are stored into the storage unit 37. After that, the power of the DVD player is turned off.

After a while, if the user turns on the power of the DVD audio player and inputs a command to resume the reproduction, firstly the group number “1”, the track number “1” and the display list number “3”, which are stored in the storage unit 37, are read, and then the display list information DL (FIG. 7) is read, on the basis of the group number “1” and the track number “1”.

Next, as shown in FIG. 7, the display list #3 in the display list information DL is checked and the reproduction starting time T2 (3′00″) of the still picture information unit #3 designated in the display list #3 is identified. Then, on the basis of the group number “1” and the track number “1”, the track #1 is identified as the track whose reproduction is to be resumed, and a reproduction position corresponding to the reproduction starting time T2 is set as the reproduction resuming position.

As a result, the reproduction of the audio information with the reproduction of the still picture information unit is resumed from the time point T2 shown in FIG. 8.

As discussed above, according to the DVD audio player of the second example, if the reproduction is interrupted, a still picture information unit to which the reproduction starting time nearest to the interruption time point is assigned is identified, and the display list number corresponding to the still picture information unit as well as the group and track numbers reproduced until the interruption are stored, and if the reproduction is to be resumed, the reproduction resuming position of the track is identified on the basis of the group and track numbers and the display list number, all of which are stored. Therefore, the reproduction can be resumed from the position at which the reproduction is interrupted or from a vicinity of the position, even after that the reproduction is interrupted. Thereby, the user can enjoy a continuous part of the music without any special manipulation, or with a simple manipulation, even after that the reproduction of the music is once interrupted.

Further, since a still picture information unit to which the reproduction starting time nearest to the interruption time point is assigned is identified, and a reproduction position corresponding to the reproduction starting time of the still picture information unit is set as a reproduction resuming position of the track, the reproduction resuming position of the track can be coincide with the still picture switching point. Thereby, the user can comfortably enjoy the still pictures, which is reproduced from the still picture switching point when the reproduction is resumed.

On the other hand, the still picture switching point is set to a “music composition changing point” or a “tone changing point” in a music composition, the reproduction of the music is resumed from the music composition changing point or the tone changing point. Therefore, the user can enjoy or listen to the music comfortably after resuming the reproduction.

Additionally, the group number, the track number and the display list number are stored, when the reproduction is interrupted. Therefore, the reproduction interruption process and the reproduction resuming process are simplified and facilitated and thereby can be executed promptly.

### Third Example

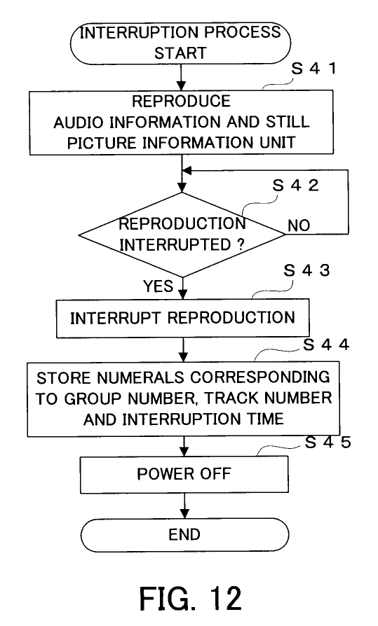

The third example of the present invention will now be discussed, with referring to FIG. 12 to FIG. 14. Incidentally, in the following third example, the same components as those in the first or second example carry the same reference numerals, and the explanations thereof are omitted as appropriate.

The DVD audio player according to the third example is of the same construction as the DVD audio player 30 according to the first example, except for the reproduction interruption process and the reproduction resuming process. Therefore, the following discussion is focused on the reproduction interruption process and the reproduction resuming process.

Firstly, the reproduction interruption process in the DVD audio player according to the third example will be discussed, with referring to FIG. 12.

FIG. 12 shows the reproduction interruption process in the DVD audio player according to the third example. As shown in FIG. 12, the system controller 36 starts the reproduction of the audio information with the reproduction of the still picture information unit (step S41), and then determines whether or not a command to interrupt the reproduction is input (step S42).

If a user inputs a command to turn off the power of the DVD audio player via the operation unit 35, the system controller 36 receives this instruction (step S42: YES), and interrupts the reproduction of the audio information with the reproduction of the still picture information unit (step S43).

Next, the system controller 36 stores the group and track numbers, which is reproduced until the interruption, and a numeral value to indicate the interruption time point (as the interruption information), into the storage unit 37 (step S44). For instance, as shown in FIG. 8, if the reproduction of the track #1 belonged to the group #1 is interrupted at a time point “ta” (2′30″), then the group number “1”, the track number “1” and a numeral to indicate 2′30″ are stored into the storage unit 37.

Then, the system controller 36 turns off the power of the DVD audio player (step S45).

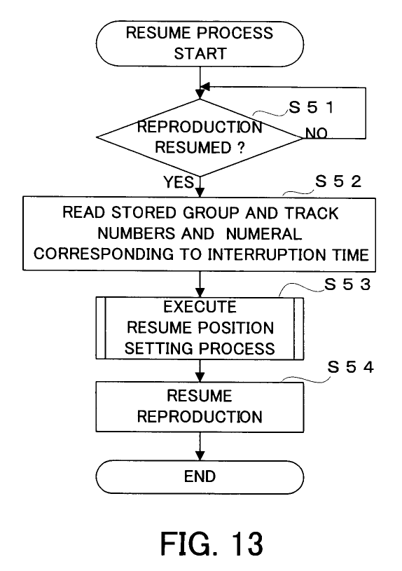

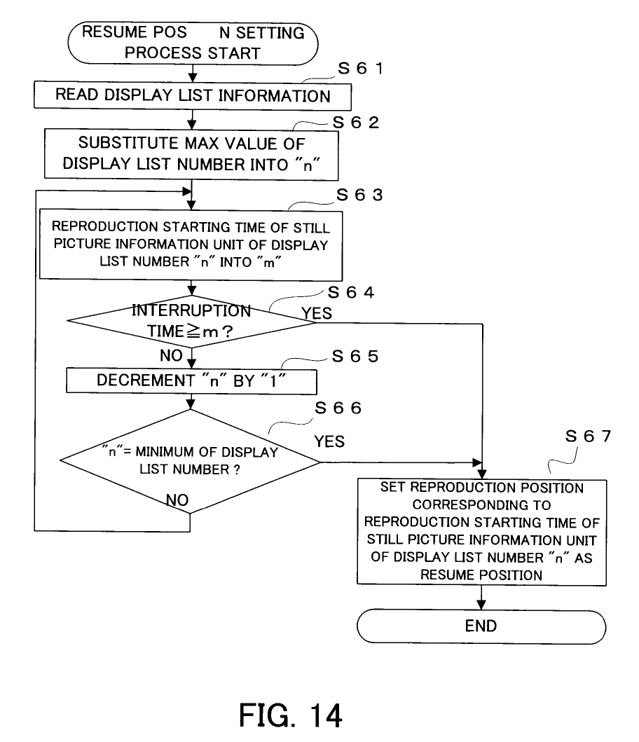

Next, the reproduction resuming process in the DVD audio player according to the third example will be discussed, with referring to FIG. 13 and FIG. 14.

FIG. 13 shows the reproduction resuming process. As shown in FIG. 13, if the power of the DVD audio player is turned on to resume the reproduction, the system controller 36 determines whether or not a command to resume the reproduction is input (step S51).

If a user inputs a command to resume the reproduction via the operation unit 35, the system controller 36 receives the instruction (step S51: YES), and then reads the group number, the track number and the numeral to indicate the interruption time point, all of which is stored (step S52).

Then, the system controller 36 executes a reproduction resuming position setting process (step S53). FIG. 14 shows a reproduction resuming position setting process that is executed at the step S53 in FIG. 13. The reproduction resuming position setting process is a process of setting a reproduction resuming position of a track, on the basis of the group number, the track number and the numeral value to indicate the interruption time point, all of which is stored in the storage unit 37.

As shown in FIG. 14, firstly, the system controller 36 reads, from the DVD 1, the display list information associated with the track (program) that is designated by the group number and the track number read from the storage unit 37 (step S61).

Next, the system controller 36 recognizes the maximum value of the display list number, on the basis of the display list information, and substitutes this maximum number into “n” (step S62).

Next, on the basis of the display list information, the reproduction starting time of the still picture information unit that is designated in the display list having the number “n” is substituted into a variable “m” (step S63).

Next, it is determined whether or not a numeral value to indicate the interruption time point equals to or more than the variable “m” (step S64).

The numeral value to indicate the interruption time point is less than the variable “m” (step S64: NO), the system controller 36 decrements “n” by “1” (step S65), and then determines whether or not the decremented variable “n” equals to the minimum value of the display list number in the display list information that is read at the step S61 (step S66).

If the decremented variable “n” does not equal to the minimum value of the display list number (step S66: NO), the process goes back to the step S63.

On the other hand, at the step S64, if the numeral value to indicate the interruption time point equals to or more than the variable “m” (step S64: YES), or if the decremented variable “n” equals to the minimum value of the display list number (step S66: YES), a reproduction position corresponding to the reproduction starting time of the still picture information unit designated by the display list having the number “n” is set as the reproduction resuming position of the audio information and the still picture information unit (step S67).

Then, the process moves to the step S54 in FIG. 13, at which the system controller 36 resumes the reproduction of the audio information and the still picture information unit from the reproduction resuming position that is set by the reproduction resuming position setting process. As a result, as for the example in FIG. 8, the reproduction of the track is resumed from the time point T1.

As discussed above, also in the DVD audio player according to the third example, similar to the DVD audio player according to the first example, it is possible to resume the reproduction from the interruption position or from a vicinity of the interruption position. Further, when the reproduction is resumed, a still picture information unit can be always reproduced from the beginning i.e. the reproduction starting time point. Therefore, in the case that the reproduction starting time point is set to the music composition changing point or the tone changing point, the reproduction of music can be resumed from the music composition changing point or the tone changing point. Therefore, the user can enjoy or listen to the music, immediately after the reproduction is resumed.

### Fourth Example

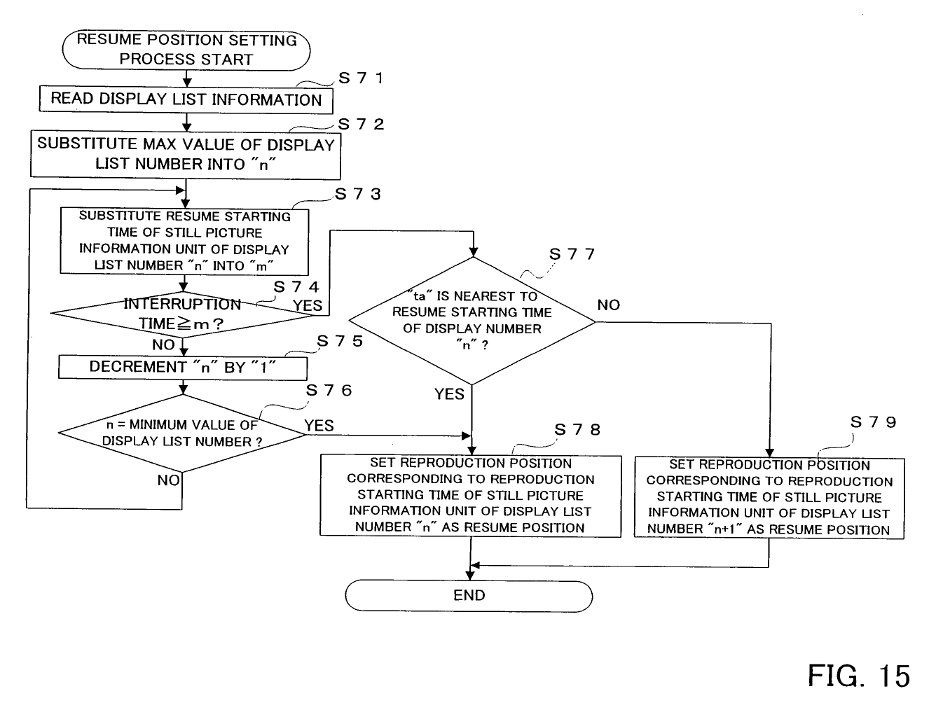

The fourth example of the present invention will now be discussed, with referring to FIG. 15. Incidentally, in the fourth example, the same components as those in the first example, the second example or the third example carry the same reference numerals, and the explanations thereof are omitted as appropriate.

The DVD audio player according to the fourth example is of the same construction as the DVD audio player according to the third example, except for a reproduction resuming position setting process in the reproduction resuming process. Therefore, the following discussion is focused on the reproduction resuming position setting process.

As discussed in the third example, the reproduction resuming position setting process is a process that is executed at the step S53 in the reproduction resuming process shown in FIG. 13, and a process of setting the reproduction resuming position of the track, on the basis of the group number, the track number and the numeral value to indicate the interruption time point, all of which are stored in the storage unit 37. The reproduction resuming position setting process in the fourth example is characterized in that a still picture information unit to which the reproduction starting time point nearest to the interruption time point is assigned is identified, and a reproduction position corresponding to the reproduction starting time point of the still picture information unit is set as the reproduction resuming position of the audio information and the still picture information unit.

FIG. 15 shows the reproduction resuming position setting process according to the fourth example. As shown in FIG. 15, firstly, the system controller 36 reads, from the DVD 1, the display list information associated with the track (program) that is designated by the group number and the track number read from the storage unit 37 (step S71).

Next, the system controller 36 recognizes the maximum value of the display list number, on the basis of the display list information, and substitutes this maximum value of the display list number into a variable “n” (step S72).

Next, on the basis of the display list information, the reproduction starting time point of the still picture information unit that is designated in the display list having the number “n” is substituted into a variable “m” (step S73).

Next, it is determined whether or not a numeral value to indicate the interruption time point equals to or more than the variable “m” (step S74).

If the numeral value to indicate the interruption time point is less than the variable “m” (step S74: NO), the system controller 36 decrements “n” by “1” (step S75), and then determines whether or not the decremented variable “n” equals to the minimum value of the display list number in the display list information that is read at the step S71 (step S76).

If the decremented variable “n” does not equal to the minimum value of the display list number (step S76: NO), the process goes back to the step S73.

On the other hand, at the step S74, if the numeral value to indicate the interruption time point equals to or more than the variable “m” (step S74: YES), then the following comparison is made, on the basis of the display list information read at the step S71, between the numeral value to indicate the interruption time point and the reproduction starting time that is designated in the display list having the number “n” (the reproduction starting time substituted into the variable “m” at present), and between the numeral value to indicate the interruption time point and a reproduction starting time that is designated in the display list having the number “n+1”. Then, from a result of the comparison, it is determined whether or not the numeral value to indicate the interruption time point is nearest to the reproduction starting time that is designated in the display list having the number “n” (step S77).

If the numeral value to indicate the interruption time point is nearest to the reproduction starting time that is designated in the display list having the number “n” (step S77: YES), a reproduction position corresponding to the reproduction starting time that is designated in the display list having the number “n” is set as the reproduction resuming position of the audio information and the still picture information unit (step S78).

On the other hand, if the numeral value to indicate the interruption time point is nearest to a reproduction starting time that is designated in the display list having the number “n+1” (step S77: NO), a reproduction position corresponding to the reproduction starting time that is designated in the display list having the number “n+1” is set as the reproduction resuming position of the audio information and the still picture information (step S79).

Incidentally, at the step S77, if the variable “n” is representative of the maximum value of the display list number in the display list information, the display list having the number “n+1” does not exist in the display list information. In this case, the process move to the step S78 to set a reproduction position corresponding to the reproduction time that is designated in the display list having the number “n” as the reproduction resuming position of the audio information and the still picture information unit.

On the other hand, at the step S76, if the decremented variable “n” equals to the minimum value of the display list number (step S76: YES), a reproduction position corresponding to the reproduction starting time of the still picture information unit that is designated in the display list having the number “n” is set as the reproduction resuming position of the audio information and the still picture information unit (step S78).

As a result, in the example shown in FIG. 8, since the reproduction starting time of the still picture information unit nearest to the interruption time point “ta” (2′30″) is T2 (3′00″), a reproduction position corresponding to the reproduction starting time T2 is set as the reproduction resuming position of the track through the above-mentioned process. Therefore, the reproduction of the track is resumed from the time point T2.

As discussed above, in the DVD audio player according to the fourth example, similar to the DVD audio player according to the second example, the reproduction can be resumed from the interruption position or from a vicinity of that position. Further, since a still picture information unit to which the reproduction starting time nearest to the interruption time point is assigned is identified, and a reproduction position corresponding to the reproduction starting time of the still picture information unit is set as the reproduction resuming position of the track, the reproduction resuming position of the track can be coincide with the still picture switching point. Further, in the case that the still picture switching time point is set to a music composition changing point or a tone changing point, the reproduction can be resumed from the music composition changing point or the tone changing point. Therefore, the user can enjoy or listen to the music after the reproduction is resumed.

Incidentally, in the above example, the track that is reproduced until the interruption is identified, by storing the group number and the track number. Nevertheless, the present invention is not limited to such an example, and the track may be identified by storing the group number and a total time extending from the beginning of the group to the reproduction position corresponding to the interruption time point.

Further the above-mentioned example, although the DVD audio player is taken as the information reproducing apparatus, the present invention is not limited to this example and can be applied to a DVD video player. Still further, also in a DVD audio player without a video reproducing function (e.g. a DVD player intended for an audio reproduction only and not including a video decoder or still picture decoder), insofar as the control information such as the reproduction list information or the like that is stored in the DVD1 can be read and recognized, the above-mentioned reproduction interruption process and the reproduction resuming process.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-270531 filed on Sep. 17, 2002 including the specification, claims, drawings and summary is incorporated herein by reference in its entirety.

What is claimed is:

1. An information reproducing apparatus for reproducing audio information and a plurality of still picture information units on the basis of reproduction control information for indicating reproduction starting time points of the respective plurality of still picture information units to be reproduced during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction starting time points;
a storing device for storing information, as interruption information, to identify a still picture information unit that is reproduced until the reproduction by the audio reproducing device or the still picture reproducing device is interrupted; and
a setting device for setting a reproduction resuming position of the audio information, on the basis of the interruption information that is stored in the storing device.

2. The information reproducing apparatus according to claim 1, wherein
the audio information includes a plurality of audio information units,
the reproduction control information indicates a reproduction starting time points of the respective plurality of still picture information units to be reproduced during a reproduction of any one of or each of the plurality of audio information units,
the storing device stores, in addition to the interruption information, unit designation information to designate an audio information unit that is reproduced until the reproduction by the audio reproducing device or the still picture reproducing device is interrupted, and
the setting device sets the reproduction resuming position of the audio information on the basis of the unit designation information and the interruption information, which are stored in the storing device.

3. The information reproducing apparatus according to claim 1, wherein the interruption information is reproduction control information of the still picture information unit that is reproduced until the reproduction is interrupted.

4. The information reproducing apparatus according to claim 1, wherein the interruption information is designation information to designate reproduction control information of the still picture information unit that is reproduced until the reproduction is interrupted.

5. The information reproducing apparatus according to claim 1, wherein the interruption information is designation information to designate the still picture information unit that is reproduced until the reproduction is interrupted.

6. An information reproducing apparatus for reproducing audio information and a plurality of still picture information units on the basis of reproduction control information for indicating reproduction starting time points of the respective plurality of still picture information units to be reproduced during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction starting time points;
a storing device for storing information, as interruption information, to identify a still picture information unit to which a reproduction starting time nearest to an interruption time point that the reproduction by the audio reproducing device or the still picture reproducing device is interrupted is assigned, and
a setting device for setting a reproduction resuming position of the audio information, on the basis of the interruption information that is stored in the storing device.

7. The information reproducing apparatus according to claim 6, wherein
the audio information includes a plurality of audio information units,
the reproduction control information indicates a reproduction starting time points of the respective plurality of still picture information units to be reproduced during a reproduction of any one of or each of the plurality of audio information units,
the storing device stores, in addition to the interruption information, unit designation information to designate an audio information unit that is reproduced until the reproduction by the audio reproducing device or the still picture reproducing device is interrupted, and
the setting device sets the reproduction resuming position of the audio information on the basis of the unit designation information and the interruption information, which are stored in the storing device.

8. The information reproducing apparatus according to claim 6, wherein the interruption information is reproduction control information of the still picture information unit to which the reproduction starting time point nearest to the interruption time point is assigned.

9. The information reproducing apparatus according to claim 6, wherein the interruption information is designation information to designate reproduction control information of the still picture information unit to which the reproduction starting time point nearest to the interruption time point is assigned.

10. The information reproducing apparatus according to claim 6, wherein the interruption information is designation information to designate the still picture information unit to which the reproduction starting time point nearest to the interruption time point is assigned.

11. An information reproducing apparatus for reproducing audio information and a plurality of still picture information units on the basis of reproduction control information for indicating reproduction starting time points of the respective plurality of still picture information units to be reproduced during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction starting time points;
a storing device for storing information, as interruption information, to indicate an interruption time point that the reproduction by the audio reproducing device or the still picture reproducing device is interrupted; and
a setting device for identifying a still picture information unit that is reproduced until the reproduction is interrupted, on the basis of the interruption information that is stored in the storing device, and for setting a reproduction resuming position of the audio information, on the basis of the identified still picture information unit.

12. The information reproducing apparatus according to claim 11, wherein
the audio information includes a plurality of audio information units,
the reproduction control information indicates a reproduction starting time points of the respective plurality of still picture information units to be reproduced during a reproduction of any one of or each of the plurality of audio information units,
the storing device stores, in addition to the interruption information, unit designation information to designate an audio information unit that is reproduced until the reproduction by the audio reproducing device or the still picture reproducing device is interrupted, and
the setting device identifies the audio information unit that is reproduced until the reproduction is interrupted on the basis of the unit designation information that is stored in the storing device, identifies the still picture information unit that is reproduced until the reproduction is interrupted on the basis of the interruption information that is stored in the storing device and sets the reproduction resuming position of the audio information on the basis of the identified audio information unit and the identified still picture information unit.

13. The information reproducing apparatus according to claim 11, wherein the setting device sets a reproduction position of the audio information corresponding to a reproduction starting time of the still picture information unit that is reproduced until the reproduction is interrupted, as the reproduction resuming position of the audio information, on the basis of the interruption information that is stored in the storing device.

14. An information reproducing apparatus for reproducing audio information and a plurality of still picture information units on the basis of reproduction control information for indicating reproduction starting time points of the respective plurality of still picture information units to be reproduced during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction starting time points;
a storing device for storing information, as interruption information, to indicate an interruption time point that the reproduction by the audio reproducing device or the still picture reproducing device is interrupted; and
a setting device for identifying a still picture information unit to which a reproduction starting time point nearest to the interruption time point is assigned on the basis of the interruption information that is stored in the storing device, and for setting a reproduction resuming position of the audio information, on the basis of the identified still picture information unit.

15. The information reproducing apparatus according to claim 14, wherein
the audio information includes a plurality of audio information units,
the reproduction control information indicates a reproduction starting time points of the respective plurality of still picture information units to be reproduced during a reproduction of any one of or each of the plurality of audio information units,
the storing device stores, in addition to the interruption information, unit designation information to designate an audio information that is reproduced until the reproduction is interrupted, and
the setting device identifies the audio information that is reproduced until the reproduction is interrupted on the basis of the unit designation information that is stored in the storing device, identifies the still picture information to which the reproduction starting time point nearest to the interruption time point is assigned, on the basis of the interruption information that is stored in the storing device, and sets the reproduction resuming position of the audio information on the basis of the identified audio information unit and the identified still picture information unit.

16. The information reproducing apparatus according to claim 14, wherein the setting device identifies the still picture information to which a reproduction starting time point nearest to the interruption time point is assigned, on the basis of the interruption information that is stored in the storing device, and sets a reproduction position of the audio information corresponding to the reproduction starting time of the identified still picture information, as the reproduction starting position of the unit of audio information.

17. An information reproducing method of reproducing audio information and a plurality of still picture information units on the basis of reproduction control information for indicating reproduction starting time points of the respective plurality of still picture information units to be reproduced during a reproduction of the audio information, the information reproducing method comprising:
an audio reproducing process of reproducing the audio information;
a still picture reproducing process of reproducing the plurality of still picture information units in sequence by switching the plurality of still picture information units one after another according to the reproduction starting time points;
a storing process of storing information, as interruption information, to identify a still picture information unit that is reproduced until the reproduction in the audio reproducing process or the still picture reproducing process is interrupted; and
a setting process of setting a reproduction resuming position of the audio information, on the basis of the interruption information that is stored in the storing process.

18. An information reproducing method of reproducing audio information and a plurality of still picture information units on the basis of reproduction control information for indicating reproduction starting time points of the respective plurality of still picture information units to be reproduced during a reproduction of the audio information, the information reproducing method comprising:
an audio reproducing process of reproducing the audio information;
a still picture reproducing process of reproducing the plurality of still picture information units in sequence by switching the plurality of still picture information units one after another according to the reproduction starting time points;
a storing process of storing information, as interruption information, to identify a still picture information unit to which a reproduction starting time nearest to an interruption time point that the reproduction in the audio reproducing process or the still picture reproducing process is interrupted is assigned, and
a setting process of setting a reproduction resuming position of the audio information, on the basis of the interruption information that is stored in the storing process.

19. An information reproducing method of reproducing audio information and a plurality of still picture information units on the basis of reproduction control information for indicating reproduction starting time points of the respective plurality of still picture information units to be reproduced during a reproduction of the audio information, the information reproducing method comprising:
an audio reproducing process of reproducing the audio information;
a still picture reproducing process of reproducing the plurality of still picture information units in sequence by switching the plurality of still picture information units one after another according to the reproduction starting time points;
a storing process of storing information, as interruption information, to indicate an interruption time point that the reproduction in the audio reproducing process or the still picture reproducing process is interrupted; and
a setting process of identifying a still picture information unit that is reproduced until the reproduction is interrupted, on the basis of the interruption information that is stored in the storing process, and for setting a reproduction resuming position of the audio information, on the basis of the identified still picture information unit.

20. An information reproducing method of reproducing audio information and a plurality of still picture information units on the basis of reproduction control information for indicating reproduction starting time points of the respective plurality of still picture information units to be reproduced during a reproduction of the audio information, the information reproducing method comprising:
an audio reproducing process of reproducing the audio information;
a still picture reproducing process of reproducing the plurality of still picture information units in sequence by switching the plurality of still picture information units one after another according to the reproduction starting time points;
a storing process of storing information, as interruption information, to indicate an interruption time point that the reproduction in the audio reproducing process or the still picture reproducing process is interrupted; and
a setting process of identifying a still picture information unit to which a reproduction starting time point nearest to the interruption time point is assigned on the basis of the interruption information that is stored in the storing process, and for setting a reproduction resuming position of the audio information, on the basis of the identified still picture information unit.

21. A computer program product in a computer-readable medium for tangibly embodying a program of instructions executable by a computer to make the computer function as an information reproducing apparatus for reproducing audio information and a plurality of still picture information units on the basis of reproduction control information for indicating reproduction starting time points of the respective plurality of still picture information units to be reproduced during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction starting time points;
a storing device for storing information, as interruption information, to identify a still picture information unit that is reproduced until the reproduction by the audio reproducing device or the still picture reproducing device is interrupted; and
a setting device for setting a reproduction resuming position of the audio information, on the basis of the interruption information that is stored in the storing device.

22. A computer program product in a computer-readable medium for tangibly embodying a program of instructions executable by a computer to make the computer function as an information reproducing apparatus for reproducing audio information and a plurality of still picture information units on the basis of reproduction control information for indicating reproduction starting time points of the respective plurality of still picture information units to be reproduced during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction starting time points;
a storing device for storing information, as interruption information, to identify a still picture information unit to which a reproduction starting time nearest to an interruption time point that the reproduction by the audio reproducing device or the still picture reproducing device is interrupted is assigned, and
a setting device for setting a reproduction resuming position of the audio information, on the basis of the interruption information that is stored in the storing device.

23. A computer program product in a computer-readable medium for tangibly embodying a program of instructions executable by a computer to make the computer function as an information reproducing apparatus for reproducing audio information and a plurality of still picture information units on the basis of reproduction control information for indicating reproduction starting time points of the respective plurality of still picture information units to be reproduced during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction starting time points;
a storing device for storing information, as interruption information, to indicate an interruption time point that the reproduction by the audio reproducing device or the still picture reproducing device is interrupted; and
a setting device for identifying a still picture information unit that is reproduced until the reproduction is interrupted, on the basis of the interruption information that is stored in the storing device, and for setting a reproduction resuming position of the audio information, on the basis of the identified still picture information unit.

24. A computer program product in a computer-readable medium for tangibly embodying a program of instructions executable by a computer to make the computer function as an information reproducing apparatus for reproducing audio information and a plurality of still picture information units on the basis of reproduction control information for indicating reproduction starting time points of the respective plurality of still picture information units to be reproduced during a reproduction of the audio information, the information reproducing apparatus comprising:
an audio reproducing device for reproducing the audio information;
a still picture reproducing device for reproducing the plurality of still picture information units in sequence by switching the plurality of still picture information units one after another according to the reproduction starting time points;
a storing device for storing information, as interruption information, to indicate an interruption time point that the reproduction by the audio reproducing device or the still picture reproducing device is interrupted; and
a setting device for identifying a still picture information unit to which a reproduction starting time point nearest to the interruption time point is assigned on the basis of the interruption information that is stored in the storing device, and for setting a reproduction resuming position of the audio information, on the basis of the identified still picture information unit.
